(19) United States
(12) Patent Application Publication
(10) Pub. No.: US 2009/0209418 A1
(43) Pub. Date: Aug. 20, 2009

(54) ADSORBENT AND METHOD FOR MANUFACTURING THE SAME

(75) Inventors: Fujio WATANABE, Owariasahi-shi (JP); Masanobu HASATANI, Nagoya-shi (JP); Katsuhiko MAKINO, Aichi-ken (JP); Tamotsu OGITA, Obu-shi (JP)

Correspondence Address: DENNISON, SCHULTZ & MACDONALD, 1727 KING STREET, SUITE 105, ALEXANDRIA, VA, 22314, US

(73) Assignees: Nagoya Electrical Educational Foundation, Nagoya-shi (JP); Aisan Kogyo Kabushiki Kaisha, Obu-shi (JP)

(21) Appl. No.: 12/372,866

(22) Filed: Feb. 18, 2009

(30) Foreign Application Priority Data
Feb. 18, 2008 (JP) 2008-035800
Dec. 15, 2008 (JP) 2008-318151
Dec. 24, 2008 (JP) 2008-327730

(51) Int. Cl. B01J 20/10; B01J 20/20

(52) U.S. Cl. 502/405; 502/417

(57) ABSTRACT

Silica gel is impregnated as an impregnating substance into pores of an activated carbon having mesopores and macropores. Since the mesopores and the macropores are impregnated with the silica gel, they are made narrow and small whereby a pore size ratio within a range of 1 to 10 nm is increased.

This application claims priority to Japanese patent application serial numbers 2008-035800, 2008-327730 and 2008-318151, the contents of which are incorporated herein by reference.

### BACKGROUND OF THE INVENTION

1. Field of the Invention

The present invention relates to an adsorbent where an impregnating substance is impregnated into pores whereby adsorptive characteristic and desorptive characteristic to evaporated fuel (which is called as “vapor” hereinafter) generated from gasoline are excellent and also relates to a method for manufacturing the adsorbent.

2. Description of the Related Art

In a fuel tank of automobiles, gasoline is evaporated to generate vapor. The evaporated amount increases when temperature of the inner area of the fuel tank becomes high due to outer temperature during stopping or due to gasoline combustion during running. An automobile has a function for discharging the gas in the fuel tank to outer air in order to control the inner pressure of the fuel tank to a constant level. However, when vapor is discharged to outer air, it causes air pollution. Therefore, a canister has been provided between a fuel tank and an opening to the outer air. The canister is filled with an adsorbent which is able to selectively adsorb and desorb the vapor. The adsorbent comprises a porous substance. When the gas from the fuel tank reaches to the canister, the vapor in the gas is adsorbed with the adsorbent. Other components in the gas are discharged into the outer air. When air is introduced into the canister from the opening by utilizing a suction pump or due to a negative pressure of suction pipe upon driving of engine, the vapor adsorbed with the adsorbent is desorbed from the adsorbent (purged).

Active carbon is generally used as an adsorbent for a canister. Activated carbon shows a porous form due to an activating treatment of various materials and, in its inner area, pores in various sizes are formed. To be more specific, micropores where pore diameter is not more than 2 nm, mesopores where pore diameter is 2 to 50 nm and macropores where pore diameter is not less than 50 nm coexist therein. Those pores form continuous pores which are basically connected each other. Pore diameters become larger from the inner area to the surficial side of the activated carbon. Adsorptive phenomenon is roughly classified into physical adsorption and chemical adsorption. Activated carbon can adsorb various substances due to mainly a reversible physical adsorption cased by van der Waals force. Such adsorption reaction of activated carbon is reversible, so that the adsorbed substance can be purged.

Micropores have a strong adsorptive force. Therefore, the micropores form an adsorptive site for the substances having a relatively small molecular size. The mesopores are utilized for adsorption of macromolecular substances having a big molecule size and for carrying (impregnation) of pharmaceuticals, etc. Mesopores also participate in the transfer of adsorbed substances which are adsorbed on the outer surface of the activated carbon to the micropores and, therefore, they also affect dynamic adsorptive characteristics and adsorptive speed. As such, the adsorptive volume of the adsorbed substances to the activated carbon is greatly affected by volume and distribution of the micropores and the mesopores. On the other hand, the macropores become passages by which adsorbed substances and ion reach the micropores, etc. and do not directly participate in the adsorptive volume of gasoline vapor. In addition, when volume of the macropores is big, density of the activated carbon becomes low and hardness also lowers. Therefore, in order to ensure the adsorptive and desorptive characteristics to the vapor, a specific type of activated carbon is needed, which will be mentioned as follows. That is, it is an activated carbon having many pores with a diameter which appropriately corresponds to the molecular size of the vapor. However, when various materials are merely subjected to an activating treatment, control of the pore diameter is difficult and it is almost impossible to prepare an activated carbon having a uniform pore diameter. Further, although improvements mostly in an increase of specific surface area have been investigated, such improvements do not directly contribute in a high efficiency because a decrease in density of the adsorbent as a result of an increase in the specific surface area does not allow an increase in the adsorptive property based on the volume.

Gasoline mostly comprises hydrocarbon of 4 to 10 carbons. During the running, etc. of an automobile, gasoline is able to be heated up to about 60° C. Accordingly, in the vapor as a result of evaporation of gasoline, not less than 90% thereof consists of low-molecular hydrocarbons such as butane, pentane or hexane. On the basis of 35° C., butane and pentane occupy about 80% ofthe vapor. Molecular diameter of the hydrocarbons as such is about 4 Å but molecular length of each of the hydrocarbons is different. It has been known that, in general, pore diameter of the activated carbon effective for adsorption of vapor is about four- to six-fold of the adsorbed molecular length. Relation between the physical property of each hydrocarbon and the effective pore size therefor is shown in Table 1.

TABLE 1

| | | | | | | Effective Pore size for |
|---|---|---|---|---|---|---|
| Carbon | Name of | Molecular | Boiling | Specific | Molecular Length × | Adsorption and |
| Numbers | Molecule | Formula | Point | Gravity | Molecular Diameter (nm) | Desorption (nm) |
| 4 | Butane | C₄H₁₀ | −1 | 0.612 | 0.5 × 0.4 | 2.0 to 3.0 |
| 5 | Pentane | C₅H₁₂ | 36 | 0.626 | 0.6 × 0.4 | 2.4 to 3.6 |
| 6 | Hexane | C₆H₁₄ | 69 | 0.659 | 0.7 × 0.4 | 2.8 to 4.2 |
| 7 | Heptane | C₇H₁₆ | 98 | 0.684 | 0.8 × 0.4 | 3.2 to 4.8 |
| 8 | Octane | C₈H₁₈ | 126 | 0.703 | 0.9 × 0.4 | 3.6 to 5.4 |
| 9 | Nonane | C₉H₂₀ | 151 | 0.718 | 1.0 × 0.4 | 4.0 to 6.0 |
| 10 | Decane | C₁₀H₂₂ | 174 | 0.730 | 1.1 × 0.4 | 4.4 to 6.6 |

It will be apparent from Table 1 that, by a BJH analysis method, most of the vapor is adsorbed with the pore region of about 2 to 4 nm. At the broadest, it is adsorbed with the pore region of about 1 to 5 nm. Accordingly, among the pores of the activated carbon, the pore region where the pore diameter is not less than 10 nm is a useless region in relation to the adsorbed amount of the vapor even if the transfer of the adsorbed substance into the inner area is taken into consideration. In addition, the pore region, where a pore diameter is not less than 10 nm, lowers the density and the hardness. On the other hand, although the micropores have a high adsorptive characteristic, there is a problem in terms of desorptive characteristic when there are too many pores where the pore diameter is less than about 1 nm. Thus, when the vapor is adsorbed with the pores where the pore diameter is less than about 1 nm, the adsorbed vapor is hardly purged due to its high adsorptive force. Accordingly, in the case that the micropores where the pore diameter is less than about 1 nm is too many, there is also a problem in terms of adsorptive and desorptive characteristics which are demanded for an adsorptive material for gasoline vapor.

Under such circumstances, JP-A-2005-035812 discloses an activated carbon where pore size distribution is made narrow by a selective clogging of pores with small pore diameter in order to improve adsorptive and desorptive characteristics to vapor. The activated carbon is prepared as a compounded activated carbon where an organic compound such as naphthalene is impregnated into pores of the activated carbon. Pores of smaller than 20 Å (2 nm) of the activated carbon are clogged in order to improve desorptive characteristic. However, improvement of the adsorptive characteristic (adsorbed amount) is not considered therein. Thus, many pores having big pore diameter which are useless in terms of an adsorptive function still remain therein.

On the other hand, JP-A-2007-181778 discloses an adsorptive material where inner surface of pores having big pore diameter is changed in order to enhance an adsorptive characteristic to vapor. Here, an organic compound in which vapor is soluble is impregnated in the inner area of mesopores and macropores of about 10 to 200 nm. As a result, vapor is absorbed with the organic compound. However, it is not a direct object therein to make the mesopores and the macropores narrow and small. In addition, a problem of de-dissolving of the vapor dissolved in the organic compound remains as well. Thus, said improvement is made based on only adsorptive removal of the vapor and there is no particular consideration in a desorptive characteristic. Further, although silica gel is used as an adsorptive material, silica gel is less effective adsorptive amount than activated carbon. Furthermore, there is also a limitation in increase of adsorbed amount by dissolving in an organic compound.

JP-A-2005-289690 discloses a compounded adsorptive material where silica gel is impregnated in the pores of the activated carbon so as to make the pores narrow and small. To be more specific, a compounded adsorptive material is manufactured via a immersing step where activated carbon is immersed in an aqueous solution of alkali metal salt of silicic acid which will become silica gel material so that the silica gel material is impregnated into the pores of activated carbon, a step of making into sol where an acid is added to the activated carbon after the immersing step so that the silica gel material is made into sol and a step of making into gel where separation into solid and liquid is conducted after the step of making into sol, the activated carbon is matured by heating and silica sol is made into gel. As a result, desorptive and absorptive characteristics to water are enhanced by a synergistic effect of making the pores narrow and small with impregnation of silica gel inherently having adsorptive and desorptive functions. However, this compounded adsorptive material is an adsorptive material for a heat pump which adsorbs water.

When activated carbon is immersed in a solution of a silica gel material, the silica gel material is impregnated into the pores of the activated carbon due to diffusion. In the diffusing impregnation as such, the impregnating speed is slow and long time is needed for impregnating deeply into the pores (to the inner part). For example, the adsorptive characteristic in the case that dicyandiamide is diffused in and adsorbed with activated carbon of 9 mm particle size is disclosed in Fujio Watanabe, et al., Kagaku Kogaku Ronbunshu, vol.10, no.4, 1984, pages 461 to 468, FIG. 4, etc. To be more specific, dicyandiamide is able to be adsorbed with the pores near the surface of the activated carbon within relatively short time. However, even when the activated carbon is immersed for 20 hours, dicyandiamide is rarely adsorbed in the central part of the activated carbon. Moreover, even after 48 hours, dicyandiamide is adsorbed only to an extent of about 18% of the equilibrated adsorptive amount in the central part of the activated carbon. Thus, when particle size of the activated carbon is big and the distance from the surface to the central part or, in other words, the pore distance is long, it is necessary to elongate the impregnating time of the silica gel material depending on such condition. Accordingly, in JP-A-2005-289690, activated carbon is immersed into a silica gel material solution for 24 to 48 hours but there is a possibility that the silica gel is not surely impregnated into the depth of the pores of the activated carbon. In addition, the adsorptive material is an adsorptive material for a heat pump which adsorbs and desorbs water. Consequently, the pore diameter is not within the range of the pore diameter which is appropriate for adsorption and desorption of gasoline vapor so that said adsorptive material is unable to be used as an adsorptive material for a canister.

The adsorbent which is filled in the canister is generally molded in a predetermined shape by kneading the powdery activated carbon with a binder. For example, in many cases, a granular adsorbent material is molded into pellets. However, in the case that silica gel material is impregnated into the pores of the powdery activated carbon and the resulting compounded activated carbon is further made into a granular adsorbent using a binder, both the impregnating and molding steps are necessary and thus the manufacture is complicated.

Further, in the granular adsorbent, there is a problem that the pore inlet of each powdery adsorbent is clogged by a binder. JP-A-06-129312 discloses a granular adsorbent where powdery activated carbon is mixed with powdery silica or the like followed by molding and burning. According to the disclosure, since silica functions as a binder for activated carbon, it is no longer necessary to use a binder which has been used up to now. Further, since silica is also a porous substance, clogging of the pores of the activated carbon is also able to be avoided. However, it is not possible to impregnate silica into the inner area of the pores of each powdery activated carbon.

Thus, there is a need in the art to provide an adsorbent having excellent adsorptive and desorptive characteristics for gasoline vapor and also a method for manufacturing the adsorbent.

### BRIEF SUMMARY OF THE INVENTION

The adsorbent of the present invention is a compounded adsorbent where an impregnating substance is impregnated into the pores of the activated carbon. The activated carbon has at least mesopores and macropores. When the impregnating substance is impregnated into the mesopores and the macropores, a ratio of pores within a range of 1 to 10 nm increases. In that case, it is preferred that at least the pore region where the pore diameter is more than 10 nm is made narrow and small. In addition, in the case that the activated carbon also has micropores, the present invention does not intend to eliminate the adsorbent where an impregnating substance is impregnated into said micropores.

Accordingly, even the region of big pore diameter which has not directly participated in adsorption of vapor is now able to be effectively utilized as a region where vapor is able to be adsorbed. As a result, an adsorptive characteristic is also improved. Further, even if the specific surface area inherent to the activated carbon is made large, a decrease in the density of the adsorbent is suppressed by impregnation of the impregnating substance into the pores. In other words, density of the activated carbon increases due to the impregnating substance. Since the density of the activated carbon increases, heat capacity and heat conductivity are also enhanced. Incidentally, specific surface area of the activated carbon greatly affects the adsorbing amount of the vapor. In the case that the ratio of pores within a range of 1 to 10 nm is increased, the ratio of pores with a diameter about 1 to 5 nm suitable for adsorbing and desorbing vapor is also certainly increased. Accordingly, a good desorptive characteristic is also ensured while the adsorbing characteristic is effectively enhanced. In addition, since the pore region with pores slightly larger than 1 to 5 nm is also remained, vapor can easily reach the depth of the continuous pores.

Silica gel is preferred as an impregnating substance. In particular, silica gel of type B is more preferred. As to an adsorbent, it is preferable to prepare a granular adsorbent by molding a plurality of granular activated carbons with silica gel as a binder. By impregnating silica gel material inherently having some adsorptive and desorptive characteristics, the adsorptive and desorptive characteristics can be enhanced further due to synergism with the absorptive and desorptive functions of the silica gel. In the case of silica gel of type B, such an effect is much higher. When silica gel is used as a binder, pore inlet of each granular activated carbon is not clogged. In that case, it is preferred that the silica gel impregnated into the pores of each granular activated carbon and the silica gel as a binder are the same material and simultaneously impregnated. Therefore, making the pore narrow and small and impregnation of each granular adsorbent can be performed simultaneously, so that it is able to make the method for the manufacture more simple.

The adsorbent as such is appropriate for filling in a canister. A canister adsorbs and desorbs the vapor generated by evaporation of gasoline stored in the fuel tank. When such adsorbent is filled in a canister, it is possible to give a canister having good absorptive and desorptive characteristics for vapor generated from a fuel tank. In the case that the adsorbent is in a form of a granular adsorbent where plural granular active carbons are fixed, permeability, etc. of the canister filled with said adsorbent are improved whereby adsorptive and desorptive characteristics are further enhanced.

The above adsorbent can be manufactured via a immersing step where activated carbon is immersed in an aqueous solution of alkali metal salt of silicic as a material for silica gel, a step of making into sol where an acid is added to the activated carbon after the immersing step and a step of making into gel where a resulting product is separated into solid and liquid after the step of making into sol and the activated carbon is matured by heating. In addition, it is possible to adopt three kinds of manufacturing methods according to the present invention. In the first and the second manufacturing methods, there are a immersing step where activated carbon having at least mesopores and macropores and having a specific surface area of 1,100 to 2,500 m²/g is introduced followed by immersing for no less than 12 hours, a step of making into sol where an acid is added to the activated carbon after the immersing step such that pH of the activated carbon added with the acid is within a range between 3 to 6 and a step for making into gel where a resulting product after the step of making into sol is separated into solid and liquid and the activated carbon is matured by heating. As a result, silica gel is fixed on the inner area of the mesopores and macropores of the activated carbon so that the pore size ratio within a range of 1 to 10 nm is increased.

In that case, it is preferred that the activated carbon is in finely pulverized particles. In such configuration, the pore distance of the activated carbon becomes short so that the time for immersing can be made short. It is able to fix silica gel in the depth of the pores more certainly for the same time as conventional immersing process.

It is preferred that the step of making into sol is conducted at the temperature which is higher than a freezing point of the aqueous solution of alkali meal salt of silicic acid and not higher than ambient temperature. In that case, molecular diameter of the silica gel becomes relatively large so that the silica gel is hardly fixed in the pores with a diameter about 1 to 5 nm. Accordingly, it is able to prevent silica gel from making the pore diameter region inherently effective for adsorption of vapor narrow and small.

In the immersing step, it is preferable to adding a chemical substance for making the pore surface of the activated carbon hydrophilic to an aqueous solution of alkali metal salt of silicic acid. Alternatively, it is preferred that, before the immersing step, a step of immersing into distilled water where the activated carbon is previously immersed into distilled water is conducted. As a result, pore surface of the activated carbon is made hydrophilic so that the silica gel material can be easily impregnated into the pores of the activated carbon and fixation is promoted as well.

Furthermore, there is a difference between the first and the second manufacturing methods. In the first manufacturing method, after the immersing step, the activated carbon achieved by the solid-liquid separation is dried and then made into sol. In that case, it is able to prevent elution of silicic acid in a low-molecular state from the activated carbon when adding an acid in a step of making into sol. In the second manufacturing method, a immersing step and a step of making into sol are carried out continuously in an aqueous solution of alkali metal salt of silicic acid. In that case, making the activated carbon pores narrow and small and granulating are able to be carried out at the same time so that the manufacturing method is able to be simplified.

The third manufacturing method is characterized in that it comprises a immersing step where activated carbon is immersed in an aqueous solution of alkali metal salt of silicic acid as a silica gel material so that the silica gel material is impregnated into the pores of the activated carbon, a step of making into sol where an acid is added to the activated carbon after the immersing step and a step of making into gel where a solid-liquid separation is carried out after the step of making into sol and the activated carbon is matured by heating. In the immersing step, it is characterized in that the activated carbon is immersed in a positive electrode side and electric field is applied to the aqueous solution. When electric field is applied to an aqueous solution of alkali metal salt of silicic acid, silicic acid ion and alkali metal ion are separated from the alkali metal salt of silicic acid by electrolysis. The silicic acid ion as a silica gel material moves to the positive electrode side while the alkali metal ion moves to a negative electrode side. As a result, the silicic acid ion concentration around the activated carbon immersed in the positive electrode side increases so that the silica gel material is impregnated in an efficient manner into the pores of the activated carbon, thereby shortening the immersing time. In addition, since sodium silicate does not become colloidal and silicic acid is in an ionic state, the silica gel material is able to be impregnated into the micropores as well.

In that case, although it is not always necessary to contact the activated carbon with the positive electrode, it is preferred that the immersing is carried out under the state where the activated carbon is contacted to the positive electrode or the activated carbon itself is used as a positive electrode. Since the activated carbon is electroconductive, in the state that electricity also runs to the activated carbon, silicic acid ion is pulled to the activated carbon so that the silica gel material can be impregnated into the more depth of the pores within shorter time.

It is preferred that, in the negative electrode side of the storage container used in the immersing step, an introducing pipe by which an aqueous solution of alkali metal salt of silicic acid is introduced from the outside of said storage container and a discharging pipe by which the aqueous solution in the storage container is discharged to the outside of the storage container are provided in an opposite manner. In addition, it is preferred that, in the immersing step, a water flow from the introducing pipe to the discharging pipe is formed at the negative electrode side. When a water flow which connects to inside and outside of the storage container is formed in the negative electrode side, the alkali metal ion produced by the electrolysis is discharged to the outside of the storage container. Therefore, purity of silicic acid ion in the aqueous solution increases, so that it is able to prevent impregnation of a thing unrelated to the production of silica gel into the pores and to efficiently impregnate silica gel to the activated carbon.

In any of the first to the third manufacturing methods, a hydrothermal step where the activated carbon is subjected to a hydrothermal treatment may be carried out after the step of making into sol and before maturing by heating. Due to the hydrothermal treatment, pores of the silica gel are made larger so that it is able to increase the pore volume and thus the adsorptive volume of the final compounded activated carbon.

### BRIEF DESCRIPTION OF THE DRAWINGS

FIG. 1 is a rough cross-sectional view of the activated carbon.

FIG. 2 is a rough cross-sectional view of the compounded activated carbon prepared by the first and the second manufacturing methods.

FIG. 3 is a flow chart of the first manufacturing method.

FIG. 4 is a flow chart of the second manufacturing method.

FIG. 5 is a flow chart of the third manufacturing method.

FIG. 6 is a schematic chart of the immersing step in the third manufacturing method.

FIG. 7 is a partially enlarged cross-sectional view of main area of the compounded activated carbon prepared by the third manufacturing method.

FIG. 8 is a schematic chart showing a modified example of an apparatus used in the immersing step in the third manufacturing method.

FIG. 9 is a flow chart of the first manufacturing method having a step of immersing into distilled water.

FIG. 10 is a flow chart of the second manufacturing method having a step of immersing into distilled water.

FIG. 11 is a flow chart of the first manufacturing method having a hydrothermal treatment step.

FIG. 12 is a flow chart of the second manufacturing method having a hydrothermal treatment step.

FIG. 13 is a graph showing the pore size distributions of an activated carbon A and an activated carbon B.

FIG. 14 is a schematic view of an apparatus used for impregnation of silica gel.

FIG. 15 is a bar graph showing the filling density.

FIG. 16 is an SEM-EDX picture of the activated carbon A.

FIG. 17 is an SEM-EDX picture of a sample A-1.

FIG. 18 is an SEM-EDX picture of a sample A-2.

FIG. 19 is an SEM-EDX picture of a sample A-6.

FIG. 20 is a bar graph showing the adsorbed amount under the condition that the relative pressure was 0.4.

FIG. 21 is a graph showing pore size distributions of the samples A, A-1, A-2 and A-6.

FIG. 22 is a graph showing a differential pore size distribution of FIG. 17.

FIG. 23 is a graph showing pore size distributions of samples B, B-1, B-2 and B-3.

FIG. 24 is a graph showing a differential pore size distribution of FIG. 19.

FIG. 25 is a graph showing the relative pressure adsorbed amount of the activated carbon A and silica gel.

FIG. 26 is a graph showing pore size distributions of the samples A-6 and A-6′.

FIG. 27 is a graph showing a differential pore size distribution of FIG. 22.

FIG. 28 is a graph showing pore size distributions of the samples B-3 and B3′.

FIG. 29 is a graph showing a differential pore size distribution of FIG. 24.

### DETAILED DESCRIPTION OF THE INVENTION

Each of the additional features and teachings disclosed above and below may be utilized separately or in conjunction with other features and teachings to provide adsorbent. Representative examples of the present invention, examples that utilize many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

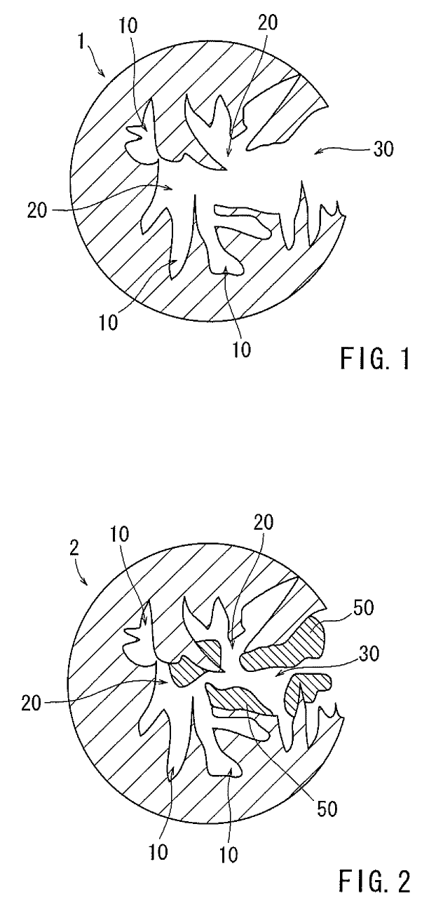

In the adsorbent of the present invention, pore size distribution is appropriately controlled for adsorption and desorption of vapor generated by evaporation of gasoline. For example, said adsorbent is filled in a canister provided in a vapor treating apparatus of automobiles. As shown in FIG. 1, the adsorbent can be made of an activated carbon 1 having continuous pores with a broad pore size distribution comprising micropores 10 where pore diameter is less than 2 nm, mesopores 20 where pore diameter is 2 to 50 nm and macropores 30 where pore diameter is more than 50 nm. As shown in FIG. 2, the absorbent can include a compounded activated carbon 2 into which an impregnating substance 50 is impregnated mostly in the mesopores 20 and the macropores 30 and a pore size ratio within a range of 1 to 10 nm is increased.

Activated carbon is a porous carbide substance prepared by subjecting various materials to an activating treatment. There is no particular limitation for the material of activated carbon and it is possible to use known materials of animal, plant type, and of synthetic resin type. Examples of the plant material can include wood (e.g., pine), bamboo, coconut shell or nut shell, coal material and animal material can include beast bone or blood. As for the material of synthetic resin type, although any of thermoplastic resin and thermosetting resin may be used, polyester, polycarbonate, phenol resin or polyimide which gives activated carbon in a high yield upon activation with chemicals are particularly preferred.

Examples of the activating treatment can include a high-temperature carbonization method where a porous product is prepared by a physical action using various types of gas, and a chemical method where a chemical substance is used. Examples of the activating gas used in the high-temperature carbonization method can include steam, carbon dioxide and air. Representative examples of the activating chemical substance used in the chemical method can include potassium hydroxide (KOH), sodium hydroxide (NaOH) and zinc chloride (ZnCl), etc. and, besides them, alkali metal salt of phosphoric acid and hydroxide of alkali metal can be used.

With regard to the specific surface area inherent to the active carbon before impregnation of an impregnating substance, it is preferred that the specific surface is as large as possible because the absolute adsorbing amount inherent to the active carbon becomes high. To be more specific, it is to be at least 500 m²/g and it is preferred to be not less than 800 m²/g which is a specific surface area level for common activated carbon. More preferably, it is not less than 1,100 m²/g and, still more preferably, it is not less than 1,500 m²/g as a result of a highly activating treatment. However, when the specific surface area is too high, problems such that it is necessary to impregnate an impregnating substance in a large amount and that density and hardness of the activated carbon greatly lower can result. Therefore, the upper limit of the specific surface area inherent to the activated carbon is to be made about 2,500 m²/g. In that case, the ratio of specific surface area of mesopores and macropores to total specific surface area of active carbon is at least more than 30% although it varies depending upon the material for the activated carbon and the degree of the activating treatment. When degree of the activating treatment is higher, there is a tendency that the ratio of specific surface area of mesopores and macropores to total specific surface area of active carbon increases as well. For example, if the specific surface area of the total activated carbon is not less than 1,100 m²/g, the ratio of specific surface area of mesopores and macropores to total specific surface area of active carbon is higher than 80%.

Adsorption of the activated carbon is mainly caused by a reversible physical adsorption, however, since functional groups (and the like) are also present on a surface, chemical adsorption may supplementarily take place as well. Further, the activated carbon itself is hydrophobic. Accordingly, the activated carbon as an adsorbent may be described as a hydrophobic adsorbent where specific surface area is big and pore size is relatively small. Although the form of the activated carbon is not particularly limited, it is preferred to be in a form of disintegrated particles. In the case of the particulate activated carbon, particle size of about 0.001 to 3.0 mm is preferred. By using the activated carbon within such a range, the impregnating substance can be easily impregnated into the pores and fundamental adsorptive and desorptive characteristics can be improved. An average particle size is about 0.005 to 2.0 mm. In addition, the activated carbon is more preferred to be in a form of finely disintegrated particles. When the particle size of the activated carbon is made smaller, the pore distance from the pore inlet in the surface of the activated carbon to the depth of the pore becomes shorter and, therefore, it is able to shorten time for introducing the impregnating substance or, in other words, time of the manufacturing the compounded activated carbon. Although the impregnating substance is actually introduced into the pores by immersing the activated carbon in an aqueous solution of the impregnating substance material as will be described later, if the immersing time is the same as before, the impregnating substance is able to be impregnated into the depth of the pores more surely. As to the degree of the fine disintegration, particle size is preferably not more than 0.25 mm (250 μm) and, more preferably, not more than 0.08 mm (80 μm). Still more preferably, the particle size is not more than 0.01 mm (10 μm). In terms of an average particle size, it is preferred to be not more than 0.1 mm.

As to the impregnating substance to be impregnated into the activated carbon, there is no particular limitation as to the impregnating substance that can be impregnated into the pores of the activated carbon in order to make the pores narrow and small. For example, silica gel and various kinds of organic compounds may be used. In impregnation of silica gel material, a common liquid phase method is used. In the case of an organic compound, a gas phase method may be used as well. Silica gel having inherently significant adsorptive and desorptive characteristics is particularly preferred. Silica gel of type B is further preferred. In silica gel, there are silica gel of type A and silica gel of type B as stipulated by JIS Z 0701. In silica gel of type A, colloidal particles are densely aggregated so that surface area is large and pore volume is small. Accordingly, adsorptive force is particularly high in the state that the vapor concentration is low. When a predetermined amount of vapor is adsorbed with silica gel of type A, the silica gel cannot further adsorb the vapor (resulting in a saturated state). On the contrary, in the case of silica gel of type B, since aggregation of the particles is rough and particle size is big, surface area is small and pore volume is big. Accordingly, it has a characteristic that, when vapor concentration becomes higher, more vapor is adsorbed therewith. As the concentration lowers, the physically adsorbed vapor is gradually purged so that silica gel of type B has high adsorptive and desorptive characteristics depending on the concentration of the vapor. The silica gel of type B has an adsorption capacity for lower hydrocarbon corresponding to about 70% of that of the activated carbon. General physical properties of silica gel of type A and silica gel of type B are shown in Table 2.

TABLE 2

Silica Gel

| | Type A | Type B |
|---|---|---|
| Specific Surface Area | 650 to 700 | 450 to 500 |
| (m²/g) | | |
| Pore Volume | 0.4 | 0.8 |
| (m/l) | | |
| Average Pore Diameter | 2.5 | 6.0 |
| (nm) | | |
| Filling Density | 0.75 | 0.50 |
| (g/ml) | | |

When silica gel is used as an impregnating substance, it is able to manufacture a compounded activated carbon by a known silica gel impregnating method which is basically a liquid phase method as mentioned above. In the present invention, two manufacturing methods in view of a rough classification are proposed. Fundamental manufacturing procedures of the present invention will be described below.

[First Manufacturing Method]

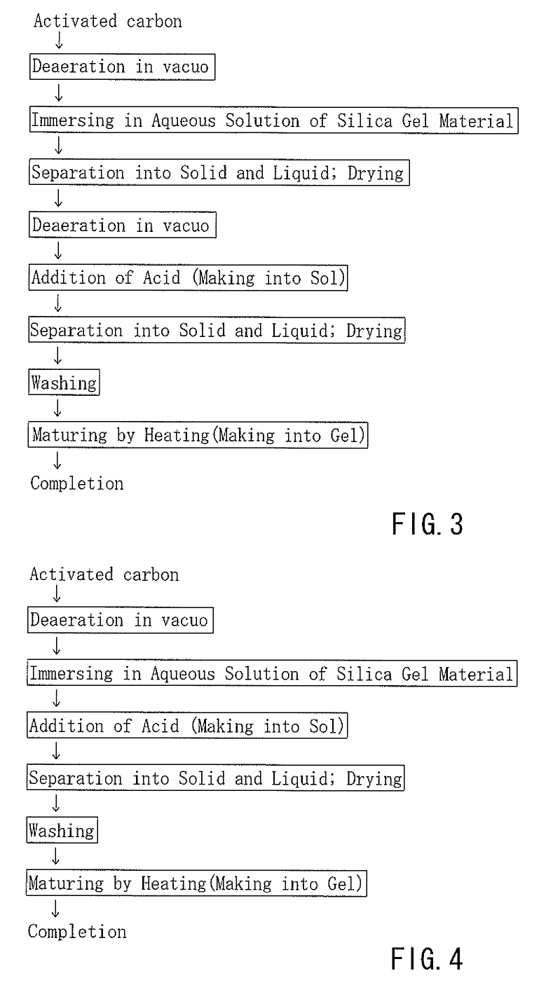

A first manufacturing method comprises an immersing step where activated carbon is immersed in an aqueous solution of a silica gel material and the silica gel material is impregnated into the pores of the activated carbon, a step of making into sol where an acid is added to the activated carbon after the immersing step in order to make the silica gel material into sol and a step of making into gel where a solid-liquid separation is carried out after the step of making into sol, and the activated carbon is matured by heating whereby the silica sol is made into gel. Procedure of impregnation of silica gel (a step for manufacturing a compounded activated carbon) in the first manufacturing method will be illustrated by referring to FIG. 3. Firstly, the activated carbon which has been subjected to an activating treatment is deaerated due to vacuum. When vacuum deaeration is carried out under a heating condition, moisture, etc. attaching to the activated carbon are detached and removed. As a result, the silica gel material can be easily introduced into the pores of the activated carbon in the latter step. The heating condition may be about 350 to 400 K.

(Immersing Step)

After unnecessary adhesive materials are removed from the activated carbon, the activated carbon is cooled and then a silica gel material is impregnated into the pores of the activated carbon. Impregnation of the silica gel material may be carried out by immersing the activated carbon in an aqueous solution of the silica gel material. An aqueous solution of alkali metal salt of silicic acid may be used for the aqueous solution of the silica gel material. For example, sodium silicate (Na₂.nSiO₃) is used as the alkali metal salt of silicic acid. When the activated carbon is immersed in an aqueous solution of alkali metal salt of silicic acid, silicic acid ion corresponding to a silica gel material is introduced into the pores of the activated carbon. At that time, impregnation of the silicic acid ion is caused by diffusion in water but its diffusing speed is slow. Accordingly, it is preferred to use the above-mentioned finely disintegrated particles. Therefore, it is now possible to shorten the immersing time and to surely impregnate into the depth of the pores.

Although concentration of the aqueous solution of alkali metal salt of silicic acid varies in relation to specific surface area and pore volume of the activated carbon used, can be approximately 0.01 to 10% by weight. When the concentration of the aqueous solution of alkali metal salt of silicic acid is too low, the finally impregnating amount of the silica gel is too small whereby it is not able to control the pore size distribution appropriately. That is, it is difficult to significantly make the pores with big pore size narrow and small. On the other hand, when the concentration of the alkali metal salt of silicic acid is too high, the finally impregnating amount of silica gel becomes too much, the pores having big pore diameter are made too narrow and small and absorptive and desorptive characteristics are rather deteriorated. As to the standard for the final impregnating amount, it is preferred that the rate of filling density (g/l) of the compounded activated carbon to the specific surface area (m²/g) of the activated carbon is made within 0.14 to 0.18. Taking the above as a rough standard, concentration of the aqueous solution of alkali metal salt of silicic acid may be appropriately adjusted depending upon the specific surface area of the activated carbon. For example, in the case that silica gel is impregnated into the activated carbon where specific surface area is about 1,100 to 2,000 (m²/g) by using an aqueous solution of sodium silicate, concentration of said aqueous solution of sodium silicate is to be made about 0.1 to 5.0% by weight or, preferably, about 0.1 to 1.0% by weight. If the impregnating amount is small by only one immersing process, then the immersing step may be repeated for a plurality of times.

As mentioned above, the active carbon is hydrophobic. Accordingly, when the silica gel material is introduced into the pores without modification, it is hard for the silica gel material to be fixed in said pores well. Therefore, it is preferred that a chemical substance which makes the pore surface of the active carbon hydrophilic is used together with the aqueous solution of alkali meal salt of silicic acid. Examples of the chemical substance for making the pore surface of the activated carbon hydrophilic can include nitric acid, ammonia, alcohol and surfactant. Each of them may be used solely or two or more thereof may be used by mixing them. As a result of making the pore surface of the activated carbon hydrophilic, impregnation and fixation of the silica gel material are facilitated.

During impregnation of the silica gel material into the activated carbon, it is preferred to stir the aqueous solution of metal salt of silicic acid. As a result of stirring, efficiency of the impregnation of the silica gel material into the pores is improved. Time for immersing is not shorter than 12 hours, preferably not shorter than 24 hours and, more preferably, not shorter than 36 hours. If the immersing time is shorter than 12 hours, it is not able to introduce the silica gel material into the pores of the activated carbon well and, in the end, to certainly make the pores narrow and small. There is no particular limitation for the upper limit of the immersing time. Taking the manufacturing efficiency into consideration, the immersing time is preferred to be within 48 hours.

(Fixing Step)

After the silica gel material is sufficiently impregnated into the activated carbon, the activated carbon prepared by means of separation into solid and liquid is dried. As a result, the silica gel material is fixed in the pores of the activated carbon. With regard to a method for the separation into solid and liquid, filter press or centrifugal separation may be used besides the common filtration means. Drying is carried out under a heating condition because, at ambient temperature, removal of moisture in the pores and fixation of the silica gel material are difficult. There is no particular limitation for the heating temperature unless the length of the heating time is particularly limited. It is preferably not lower than 330 K and, more preferably, not lower than 350 K. It is able to shorten time for the heating by making the heating temperature high. For example, when drying is carried out at the temperature of about 350 to 400 K, the heating time may be about 2 to 4 hours. On the other hand, when the heating temperature is too high, there is a risk of denaturation of the silica gel material and, therefore, its upper limit is made about 500 K.

(Step for Making into Sol)

When the activated carbon (after introduction of the silica gel material) is well dried, it is deaerated again in vacuo and the silica gel material is hydrolyzed under an acidic condition to make into sol. To be more specific, the activated carbon (where a silica gel material is introduced into the pores) is immersed in an aqueous solution of sulfuric acid. A time period for making into sol is about 12 to 48 hours utilizing a pH from 3 to 6. As to the acid, there is no particular limitation so far as it is able to hydrolyze the silica gel material. Generally, sulfuric acid can be used. In the case that silicic acid is used as the silica gel material, the following reaction takes place upon the reaction of said sodium silicate with sulfuric acid.
Na₂.3.3SiO₂+H₂SO₄+5.6H₂O→3.3SiO(OH)₄+Na₂SO₄

Although it is possible to make into sol at a temperature not lower than ambient temperature, it is preferred to be carried out at the temperature as low as possible. To be more specific, it is carried out at a temperature not higher than ambient temperature (room temperature). As shown in the above reaction formula, sodium silicate exists in a form of a hydrate. The number of hydrate increases when the temperature is lower. That is, as the number of the hydrate increase, molecular diameter of sodium silicate molecule becomes bigger. Accordingly, impregnation of sodium silicate into the pores with about 1 to 5 nm diameter is suppressed and thus it is able to prevent silica gel from making the pore size region inherently effective for adsorption and desorption of vapor narrow and small. Incidentally, the lower limit for making into sol is higher than a freezing point because, when an aqueous solution is coagulated, reaction of making into sol is prevented. Thus, the temperature for making into sol is preferred to be higher than the freezing point of the aqueous solution and not higher than ambient temperature.

It is also preferred to stir during immersion in an aqueous solution of sulfuric acid. The reason is the same as that in the case of the immersing step. It is also possible to control pore volume and surface area of silica gel by altering the pH of the aqueous solution of sulfuric acid. To be more specific, silica gel of type A is formed with a pH at about 5 to 6, and silica gel of type B can be formed using a pH of about 3 to 4.

(Step for Making into Gel)

After the step of making into sol, a solid-liquid separation and drying are carried out again as same as in the case after the immersing step. After that, sodium sulfate produced in the step of making into sol is removed by washing and then maturation by heating is carried out to give a compounded activated carbon in which a silica gel layer is formed in the pores. Since the skeleton particles of silica gel are about 1 to 10 nm, silica gel is hardly impregnated into the micropores of the activated carbon. However, a part of the micropores may be sometimes clogged by silica gel fixed on the place near the inlet of said micropores. The washing should be repeated until the electric conductivity of the aqueous solution containing the compounded activated carbon reaches about 420 to 600 μS/cm. The condition for the maturation by heating is about 380 to 500 K for about 12 to 48 hours.

The compounded activated carbon prepared as such is filled into a canister in its particle form or after being molded into particles of a predetermined shape. Upon molding into particles, the molding can be carried out by kneading the plural active carbon particles with a binder followed by subjecting to a known molding method such as an extrusion molding. As to the particle shape, pellets (columns) are preferred. Besides that, polyhedral columns, elliptic form, etc. may be also acceptable. In the first manufacturing method, since the fixing step is carried out between the immersing step and the step of making into sol, impregnation of the silica gel material and pH adjustment with an acid are carried out in two separate stages. As a result, it is able to prevent solubilization of silicic acid in a low molecular state and thus elution of silicic acid from the activated carbon when an acid is added in a step of making into sol.

[Second Manufacturing Method]

A second manufacturing method will be illustrated by referring to FIG. 4. Although a fixation step is carried out between the immersing step and the step of making into sol in the above-mentioned first manufacturing method, said fixation step may be omitted. That is, even the second manufacturing method comprises a immersing step where activated carbon is immersed in an aqueous solution of a silica gel material and the silica gel material is introduced into the pores of the activated carbon, a step of making into sol where an acid is added to the activated carbon after the immersing step so that the silica gel material is made into sol and a step of making into gel where the activated carbon is matured by heating so that the silica gel is made into gel the same as in the above-mentioned first manufacturing method. However, in the second manufacturing method, an immersing step and a step of making into sol are carried out continuously in an aqueous solution of the silica gel material.

In the second manufacturing method, the manufacturing condition in each of the steps may be also carried out under the same condition as in the above-mentioned first manufacturing method. To be more specific, a pre-treatment for a immersing step, a immersing step, a step of making into sol, steps for solid-liquid separation and washing after the step of making into sol and a step of making into gel are fundamentally the same as those in the first and the second manufacturing methods. However, in the step of making into sol in the second manufacturing method, an acid is added to the aqueous solution of the silica gel material such that pH of the aqueous solution added with the acid is within a range between 3 to 6 without carrying out solid-liquid separation after the immersing step. As a result, at the end, the silica gel is fixed in mesopores and macropores the same as in the case of the first manufacturing method whereby a compounded activated carbon (where the pore size distribution within a range of 1 to 10 nm) is enhanced is able to be prepared.

When the step of making into sol is carried out after the immersing step in an aqueous solution of a silica gel material or, in other words, an aqueous solution of alkali metal salt of silicic acid, silica sol is fixed in the pores due to the silica gel material which is introduced into the pores of the activated carbon. At the same time, silica sol is also fixed on the surface of each activated carbon due to the silica gel material suspended in the aqueous solution. Then the finely disintegrated activated carbon particles are adhered to each other by the silica sol fixed on the surface of the activated carbon, thereby giving larger particles. Therefore, it is able to mold the activated carbon simultaneously with fixation of the silica gel on the pores. Then, a step of making into gel is carried out after a solid-liquid separation and washing whereby adsorbent particles comprising the compounded activated carbon are able to be prepared. When the particle size of said adsorbent particles is big, the particles may be appropriately disintegrated into a predetermined particle size and filled in a canister.

[Third Manufacturing Method]

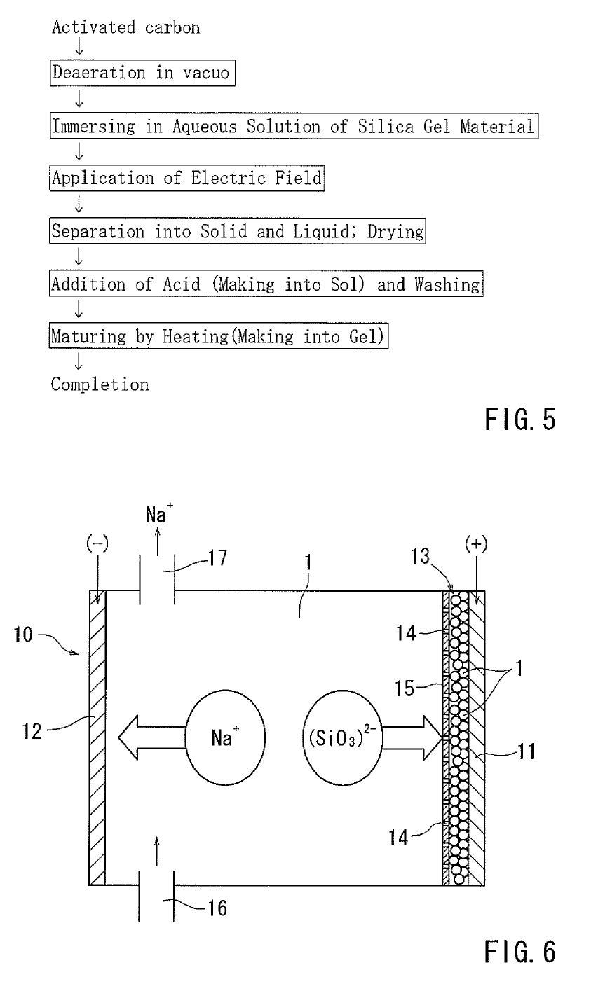

A third manufacturing method also comprises an immersing step where a silica gel material is impregnated into pores of an activated carbon by immersing the activated carbon in an aqueous solution of alkali metal salt of silicic acid as the silica gel material, a step of making into sol where an acid is added to the activated carbon after the immersing step and a step of making into gel where a solid-liquid separation is carried out and the activated carbon is matured by heating after the step of making into sol. These steps are principally the same as in the first and the second manufacturing methods. The difference of the third method from the first and the second methods is that, as shown in a flow chart of FIG. 5, an electric field or current is applied to an aqueous solution in the immersing step. It will be described mainly in the characteristic point in the third manufacturing method.

(Immersing Step)

After excessively adsorbed items are desorbed from the activated carbon by deaeration in vacuo, the activated carbon is cooled and then a silica gel material is impregnated into the pores of the activated carbon. In impregnation of the silica gel material, the activated carbon is immersed in an aqueous solution of alkali metal salt of silicic acid. As shown in FIG. 6, a positive electrode 111 and a negative electrode 112 are positioned facing oppositely on both left and right ends of the storage container 110 containing an aqueous solution of alkali metal of silicic acid 101. On the side of the positive electrode 111, an activated carbon housing space 113 is formed. The activated carbon 1 is filled in the activated carbon housing space 113. A frame wall 115 having many through holes 114 delimits the activated carbon housing space 113. The frame wall 115 may be formed integrally with the storage container 110 or another housing container different from the storage container 110 may be provided in the storage container 110. In the case that such housing container is used, a part of a peripheral wall of said receiving container forms the frame wall 115. In addition, the housing container can be made of a meshed material.

The activated carbon 1 may not be always contacted by positive electrode 110 so far as it positioned near the positive electrode 110. The activated carbon 1 is preferred to be immersed in a state contacting to the positive electrode 110. For example, when a housing container is used as the frame wall 115, the positive electrode 110 can be positioned near the outside of said housing container. It is preferred that the positive electrode 110 is placed in the housing container. When the frame wall 115 is molded integrally with the storage container 110, it is made into a single wall. On the side of the negative electrode 112 of the storage container 110, the storage container 110 includes a pipe 116 for introducing an aqueous solution of alkali metal salt of silicic acid from outside of the storage container 110 and a discharging pipe 117 for discharging an aqueous solution 101 in the storage container 110 to outside of the storage container 110. The introducing pipe 116 and the discharging pipe 117 are formed in an opposite manner in terms of top and bottom so that they are made parallel to each other. Incidentally, the introducing pipe 116 and the discharging pipe 117 may be located in reverse.

In the state that the activated carbon 1 is immersed in an aqueous solution 101 of alkali metal salt of silicic acid, an electric field is applied between the positive electrode 111 and the negative electrode 112 while generating a water flow parallel to the negative electrode 112 between the introducing pipe 116 and the discharging pipe 117. As a result, the aqueous solution 101 of alkali metal salt of silicic acid is electrolyzed to separate into silicic acid ion and alkali metal ion. For example, when electric field is applied to an aqueous solution of sodium silicate (Na₂OSiO₂), the salt is separated into a silicic acid ion ((SiO₃)²⁻) and sodium ion (Na⁺). The silicic acid ion is then pulled toward the side of the positive electrode 111 while the alkali metal salt ion is pulled toward the side of the negative electrode 112. In that state, if the activated carbon 1 is immersed in contact with the positive electrode 111, electricity also runs to the positive electrode 111 so that the silicic acid ion is also pulled toward the positive electrode 111. Reactions in the electrodes 111 and 112 are as follows.
Positive electrode, activated carbon: 2OH⁻+SiO₃²⁻→H₂O+SiO_{2 +O}₂+4e⁻
Negative electrode: 2H₂O+2e→H₂+2OH⁻

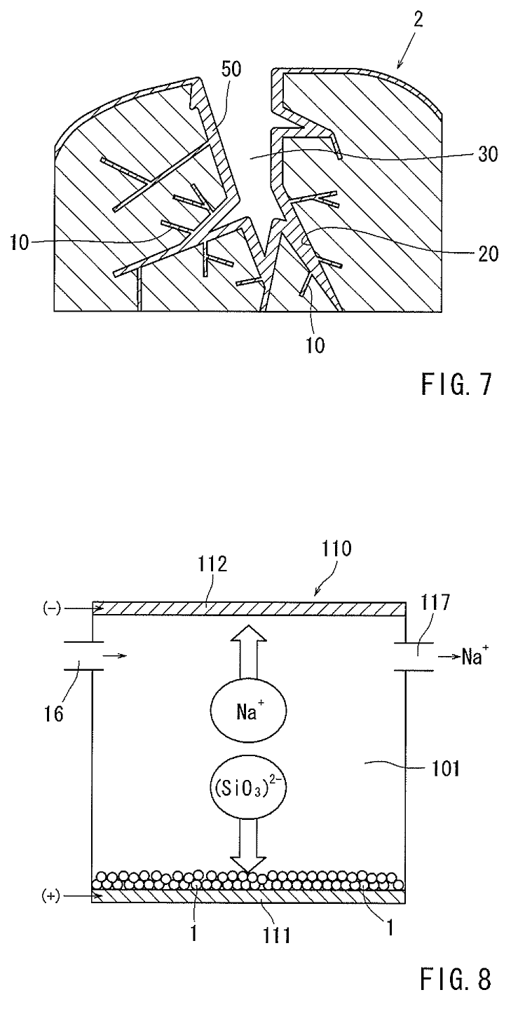

When an electric field is applied to the aqueous solution 101, the silica gel material in an ionic state is impregnated evenly into the micropores of the activated carbon 1 quickly and precisely. As a result, as shown in FIG. 7, it is able to prepare a compounded activated carbon 2 in which the silica gel 50 is fixed not only in the mesopores 20 and the macropores 30 but also in the micropores 10. Since there is a flow of liquid running inside from the outside of the storage container 110 at the side of negative electrode 112, the alkali metal ion (which is unnecessary as a silica gel material) can be discharged to outside of the storage container 110.

Intensity of the electric field is preferred to be about 0.01 to 1.0 VA. When the intensity of the electric field is lower than 0.01 VA, ionization of alkali metal salt of silicic acid is insufficient. Further, electric migration of silicic ion weakens and it becomes difficult to efficiently introduce the silica gel material into the pores of the activated carbon. When intensity of the electric field is higher than 1.0 VA, the operation is difficult. Immersing time is made about 10 to 48 hours. When the immersing time is shorter than that, an impregnated amount is too small. When it is longer than that, although the silica gel material is impregnated sufficiently, the immersing time becomes nearly the same as in the case of diffusion impregnation. For example, when silica gel is fixed in the pores of the activated carbon at the rate of 0.3 g/cc so as to make the rate of the filling density (g/l) of the compounded activated carbon to the specific surface area (m²/g) of the activated carbon 0.14 to 0.18, intensity of the electric field and impregnating time may be made about 0.1 to 0.5 VA and about 10 to 20 hours, respectively.

(Fixing Step)

After the silica gel material is sufficiently impregnated into the activated carbon, the activated carbon prepared by separating into solid and liquid is dried in order to fix the silica gel material in the pores of the activated carbon. With regard to a method for the separation into solid and liquid, filter press or centrifugal separation may be used besides the common filtration means. Drying is carried out under a heating condition. That is because removal of moisture in the pores and fixation of the silica gel material are difficult at ambient temperature. There is no particular limitation for the heating temperature unless the length of the heating time is particularly limited. It is preferably not lower than 330 K and, more preferably, not lower than 350 K. When the heating temperature is made high, it is able to shorten the time for heating. For example, when drying is carried out at the temperature of about 350 to 400 K, the drying time is likely not shorter than 24 hours. On the other hand, when the heating temperature is too high, there is a risk of denaturation of the silica gel material and, therefore, its upper limit is made about 500 K.

(Step of Making into Sol and of Washing)

After the activated carbon impregnated with the silica gel material is sufficiently dried, the activated carbon is washed under an acidic condition. As a result of washing under an acidic condition, the silica gel material is simultaneously made into sol. To be more specific, the activated carbon impregnated with the silica gel material is introduced into an aqueous solution of sulfuric acid. As for making into sol and washing, they are repeated until the electric conductivity of the aqueous solution becomes about 420 to 600 μS/cm at a pH 3 to 6. For a purpose of making into sol and washing efficiently, it is preferred that the aqueous solution is stirred. Further, the pore volume and surface area of the silica gel is able to be controlled by adjusting a pH of the aqueous solution of sulfuric acid. To be more specific, silica gel of type A is formed under a condition that the pH is relatively high (such as about 5 to 6) while silica gel of type B is formed under another condition that the pH is relatively low (such as about 3 to 4).

(Step of Making into Gel)

After the step of making into sol, solid-liquid separation and drying are carried out again in the same way as the process after the immersing step. After that, sodium sulfate produced in the step of making into sol is removed by washing and then maturation by heating is carried out. As a result, the compounded activated carbon 2 where silica gel 50 is impregnated into each of the pores 10, 20, 30 is prepared as shown in FIG. 7. To be more specific, the macropores 30 and the mesopores 20 of the compounded activated carbon 2 are made narrow and small by the silica gel 50. On the other hand, the micropores 10 are clogged by the silica gel 50. Other detailed conditions may be the same as those in the first and the second manufacturing methods.

### Modified Embodiment

In the above-mentioned third manufacturing method, the positive electrode 111 is provided separately from the activated carbon 1. However, the embodiment is not limited thereto, the activated carbon itself may be made into a positive electrode. For example, a conductive wire may be directly connected to a product where activated carbon particles are made into granules in a predetermined shape or to the activated carbon in a predetermined shape. When the activated carbon (which is in a predetermined shape or is made into granules of a predetermine shape) is used as the positive electrode, the frame wall 115 is not necessary. Alternatively, a conductive wire may be directly connected to the activated carbon filled in a housing container.

In the third manufacturing method, although the electrodes 111, 112 and the water flow are provided in a longitudinal direction, as shown in FIG. 8, the electrodes 111, 112 and the water flow may also be provided in a transverse direction. To be more specific, the positive electrode 111 is disposed at the bottom of the storage container 110 and the negative electrode 112 is disposed at the top of the storage container 110. The introducing pipe 116 and the discharging pipe 117 are formed in an opposite manner in at both right and left sides. In this case, when the activated carbon having high specific gravity and sinking in an aqueous solution of alkali metal salt of silicic acid is used, the activated carbon sinks in the storage container 110, therefore the frame wall 115 is not necessary. In the case of the activated carbon having low specific gravity and floating on the aqueous solution of alkali metal salt of silicic acid, the activated carbon is kept at the bottom by a cover-shaped frame wall 115.

(Other Manufacturing Methods)

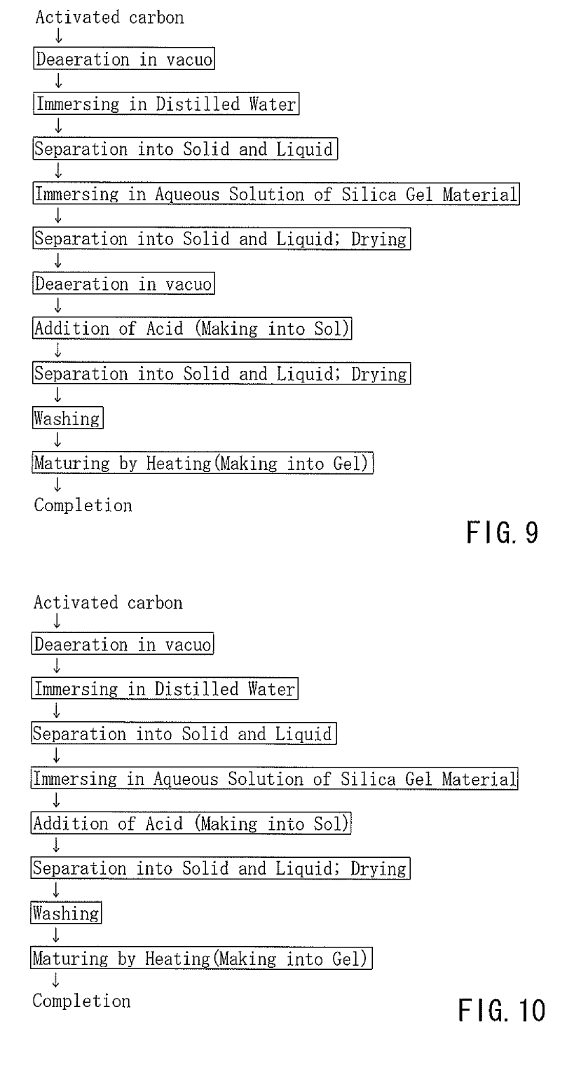

In the above first and second manufacturing methods, it is preferred that a chemical substance such as nitric acid or surfactant is added to an aqueous solution of alkali metal salt of silicic acid in a immersing step whereby the pore surface of the activated carbon is made hydrophilic so that impregnation and fixation of the silica gel material are facilitated. Besides that, as shown in FIGS. 9 and 10, a step of immersing into distilled water (where the activated carbon deaerated in vacuo is immersed in distilled water) may be carried out before the immersing step. As a result, the pore surface of the activated carbon becomes a wet state and the silica gel material is apt to be easily diffused and introduced. Time for immersing in distilled water may be 1 to 3 hour(s). After the step of immersing in distilled water, separation into solid and liquid is carried out and then the activated carbon is immersed in an aqueous solution of the silica gel material in the same way as in the case of the first and the second manufacturing methods. The procedures after that are the same as above.

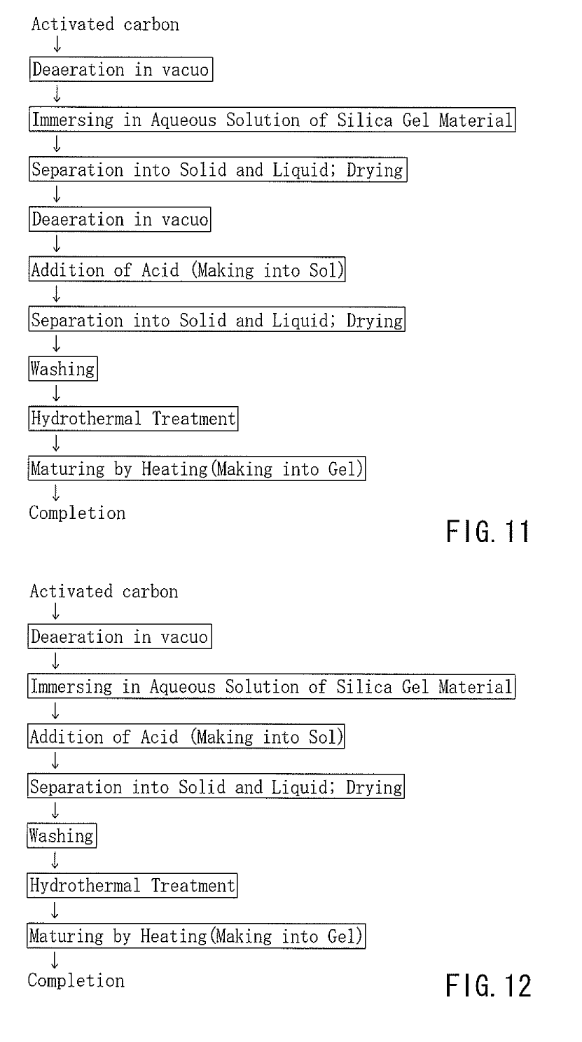

In the above first and second manufacturing methods or in a manufacturing method having a step of immersing in distilled water as shown in FIGS. 9 and 10, it is also preferred that, between the washing step and the maturation by heating, the compounded activated carbon is subjected to a hydrothermal treatment as shown in FIGS. 11 and 12. When the activated carbon, into which the silica gel material is introduced as in the case of the first and the second manufacturing methods, is matured by heating after washing without other treatment, the formation of pores of silica gel may be insufficient. In addition, in some concentrations of alkali metal salt of silicic acid, there is a risk that the pores of the activated carbon are clogged due to impregnation of silica gel of more than the necessary amount for making the pores narrow and small. If so, there is a risk that pore volume of the compounded activated carbon decreases and, as a result, the adsorbed amount lowers. Said problem becomes more significant as the concentration of alkali metal salt of silicic acid in the aqueous solution of silica gel material becomes higher.

When the step for a hydrothermal treatment is carried out before the maturation by heating, pores of the silica gel well develop as a result of the hydrothermal treatment so that it is able to avoid the above-mentioned problems. To be more specific, network of the silica gel particles (skeleton particles) is reconstituted by the hydrothermal treatment and, as a result, pores of the silica gel are sufficiently develop. When pores of the silica gel develop, pore volume of the compounded activated carbon increases. In addition, even if the pores of the activated carbon are clogged by silica gel, the pores of the silica gel itself can serve as pores of the compounded activated carbon. The hydrothermal treatment is carried out in a heated steam environment. The temperature of the hydrothermal treatment is not lower than 100° C. or, preferably, not lower than 120° C. Although there is no particular limitation for its upper limit, it may be made about 250° C. The hydrothermal treatment is preferably carried out under a pressurized condition. In the case that the step for a hydrothermal treatment is carried out, the heating time for maturation by heating may be shorter as compared with the case that no hydrothermal treatment is carried out. It is also possible to apply one or both of the step of immersing in distilled water and the step of hydrothermal treatment to the third manufacturing method.

### EXAMPLES

<Activated Carbon>

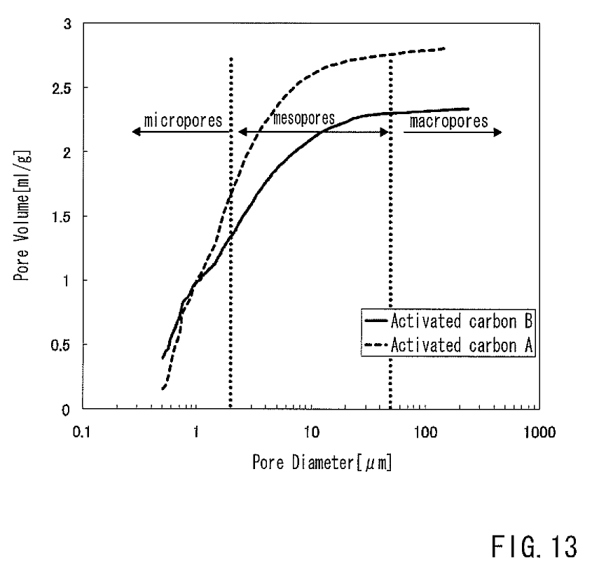

BAX 1500 (activated carbon A), which is a wood-type activated carbon activated with phosphoric acid, of Mead Westvaco and granular Shirasagi KL (activated carbon B), which is a wood-type activated carbon activated by KOH, of Nippon Enviro Chemicals, were used as activated carbons. The pore diameter distributions of the activated carbon A and the activated carbon B are shown in FIG. 13, and various physical properties of the activated carbon A and the activated carbon B are shown in Table 3. It is apparent from FIG. 13 that many mesopores are present in both of the activated carbon A and the activated carbon B. It is also noted from Table 3 that micropore volume is bigger in the activated carbon A than in the activated carbon B. Specific surface area was measured by an N₂ adsorption method and a filling density was measured by a particle filling method. In both of the activated carbon A and the activated carbon B, a particle size was limited within the range between 0.075 and 0.212 mm and average particles size was made 0.1 mm in order to easily impregnate the silica gel into the pores.

TABLE 3

| | Activated | |
|---|---|---|
| | carbon A | Activated carbon B |
| Specific Surface Area (m²/g) | 1950 | 1190 |
| Specific Surface Area of Mesopores | 1586 | 1025 |
| and Macropores (m²/g) | | |
| Volume of Micropores (ml/g) | 0.22 | 0.11 |
| Specific Surface Area of Micropores | 360 | 167 |
| (m²/g) | | |
| Filling Density (g/ml) | 0.260 | 0.247 |

<Manufacturing Method>

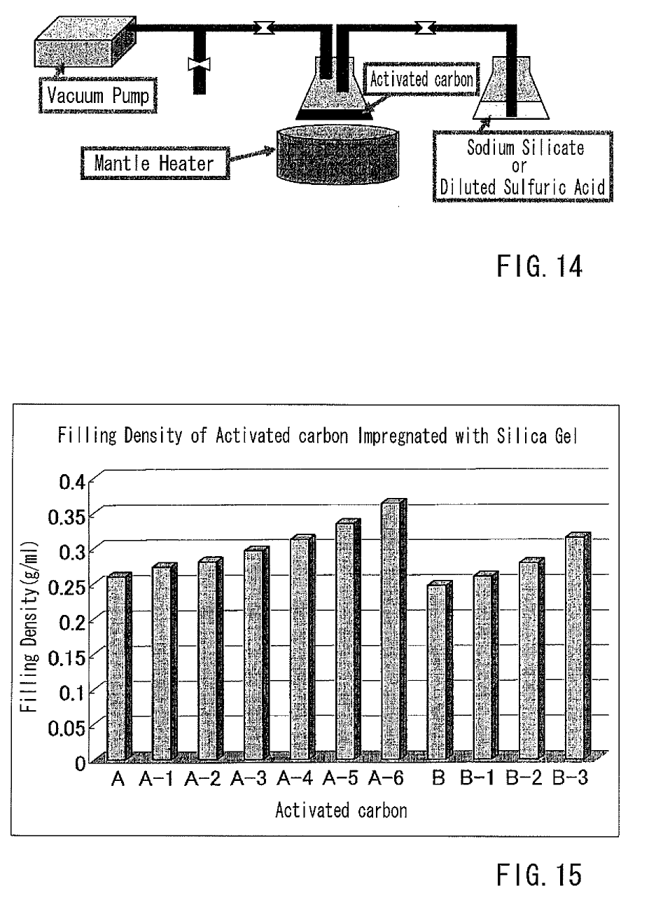

Silica gel was impregnated into the pores of the activated carbon A and the activated carbon B as follows. A schematic constitution of the apparatus used therefor is shown in FIG. 14. Firstly, 10 cc of activated carbon was placed in a flask and deaerated in vacuo by a vacuum pump for 2 hours under a heat of 383 K using a mantle heater. After that, it was cooled and 150 cc of 0.1 to 10% by weight aqueous solution of sodium silicate (Na₂.3.3SiO₂) was introduced into the flask utilizing the vacuum state. The activated carbon was immersed therein for 48 hours while stirring the sodium silicate solution at 100 rpm. After that, filtration was carried out during 10 minutes, and then the activated carbon (after the solid-liquid separation) was dried at 383 K for 24 hours in a thermostat. Then the activated carbon was deaerated in vacuo again under the same condition as above. By adding 75 cc of 1.95 mol/l sulfuric acid, the activated carbon was immersed therein for 24 hours at room temperature under the same condition as above. Solid-liquid separation and drying were carried out again in the same manner. After that, washing was repeated for ten times until the electric conductivity of the aqueous solution became not more than 600 μS/cm. Incidentally, the initial electric conductivity was about 850 μS/cm. Lastly, maturing was conducted by heating at 423 K for 24 hours to give a compounded activated carbon.

<Samples>

Plural samples having various concentrations of an aqueous solution of sodium silicate were prepared. To be more specific, a sample A-1 where concentration of aqueous solution of sodium silicate was made 0.1% by weight to the activated carbon A, a sample A-2 where the concentration was made 1.0% by weight, a sample A-3 where the concentration was made 2.5% by weight, a sample A4 where the concentration was made 5.0% by weight a sample A-5 where the concentration was made 7.5% by weight and a sample A-6 where the concentration was made 10% by weight and also a sample B-1 where the concentration was made 0.1% by weight to the activated carbon B, a sample B-2 where the concentration was made 1.0% by weight and a sample B-3 where the concentration was made 10% by weight, all were prepared. Each of those samples was subjected to a quantitative evaluation based on the adsorptive characteristic for n-butane.

<Property Evaluation>

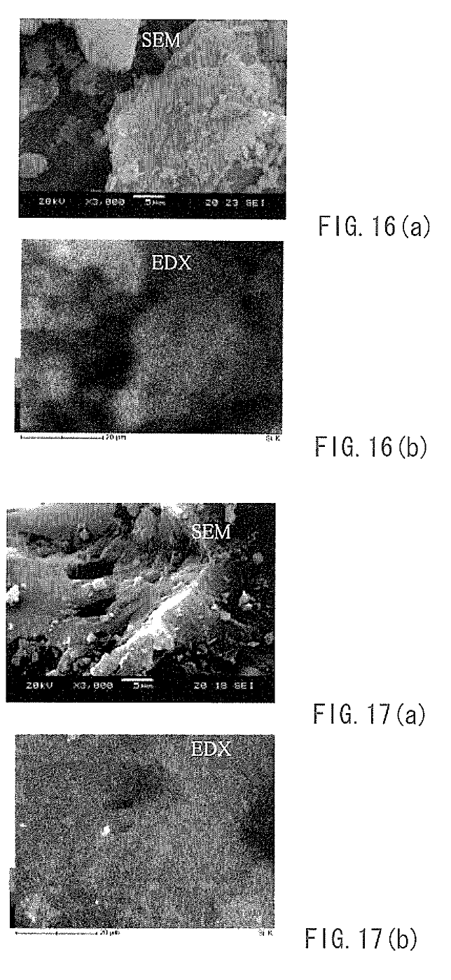

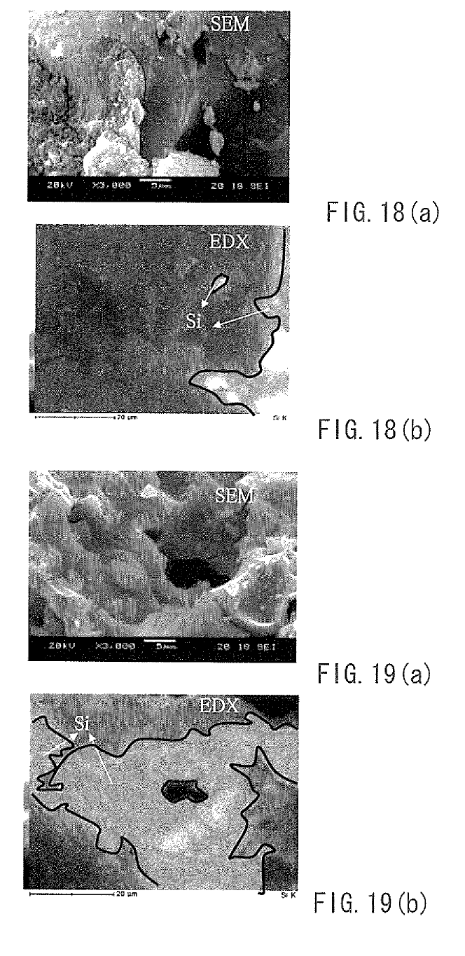

Each activated carbon and sample was subjected to (1) measurement of specific surface area and pore size distribution using a fully automated measuring apparatus for adsorbed gas (manufactured by Yuasa Ionics), (2) measurement of isothermal curve of n-butane adsorption using a highly precise measuring apparatus for adsorbed vapor (BELSORP max manufactured by Nippon Bell) and (3) observation of pore surfaces of activated carbon using SEM (scanning electron microscope)-EDX (energy dispersive fluorescent X-ray spectroscopy). Various physical properties of the samples A-1, A-2 and A-6 are shown in Table 4. Element mass rates of the activated carbon A and the samples A-1, A-2 and A-6 are shown in Table 5. FIG. 15 shows filling density of the samples A-1 to A-6 and the samples B-1 to B-3 by way of bar graphs. FIGS. 16 to 19 show SEM pictures and EDX pictures of the activated carbon A and the samples A-1, A-3 and A-6, respectively.

TABLE 4

| | Sample | | Sample |
|---|---|---|---|
| | A-1 | Sample A-2 | A-6 |
| Specific Surface Area (m²/g) | 1700 | 1650 | 1240 |
| Specific Surface Area of Mesopores | 1347 | 1280 | 595 |
| and Macropores (m²/g) | | | |
| Volume of Micropores (ml/g) | 0.25 | 0.25 | 0.30 |
| Specific Surface Area of Micropores | 364 | 371 | 646 |
| (m²/g) | | | |

TABLE 5

| | Activated | | | Sample |
|---|---|---|---|---|
| | carbon A | Sample A-1 | Sample A-2 | A-6 |
| Carbon (% by weight) | 99.41 | 99.48 | 97.43 | 53.17 |
| Oxygen (% by weight) | 0.31 | 0.28 | 1.37 | 24.94 |
| Silicon (% by weight) | 0.27 | 0.24 | 1.20 | 21.89 |

It is noted from Table 4 that, as the concentration of the aqueous solution of sodium silicate increases, the specific surface area of the compounded activated carbon decreases, that the specific surface area of the mesopores and the macropores decreases and that the specific surface area of the micropores increases. In addition, it is noted from FIG. 15 that the filling density of the compounded activated carbon increases as the concentration of an aqueous solution of sodium silicate increases. The filling density of the sample A-6 where the concentration of an aqueous solution of sodium silicate was 10% by weight was about 1.4-fold of that of the activated carbon A. The filling density of the sample B-3 was about 1.3-fold of that of the activated carbon B. It is noted from FIGS. 16 to 19 and Table 5 that the presence of silica gel was not confirmed in the activated carbon A and the component was mostly carbon. The presence of silica gel was not so markedly confirmed in the sample A-1 as well. The cause thereof is due to the fact that impregnating amount of silica gel into the pores is small. On the other hand, the presence of silica gel was able to be confirmed in the samples A-2 and A-6. Particularly in the sample A-6, it was able to be confirmed that silica gel is abundantly present. As a result, it has been found that it is able to increase the micropores because of making the activated carbon pores narrow and small and increase the activated carbon particle density by impregnating silica gel, and that, as the concentration of sodium silicate is higher, sodium silicate molecules can be easily introduced to the activated carbon pores whereby abundant silica gel is able to be impregnated into the activated carbon pores.

<Evaluation of Adsorbed Amount>

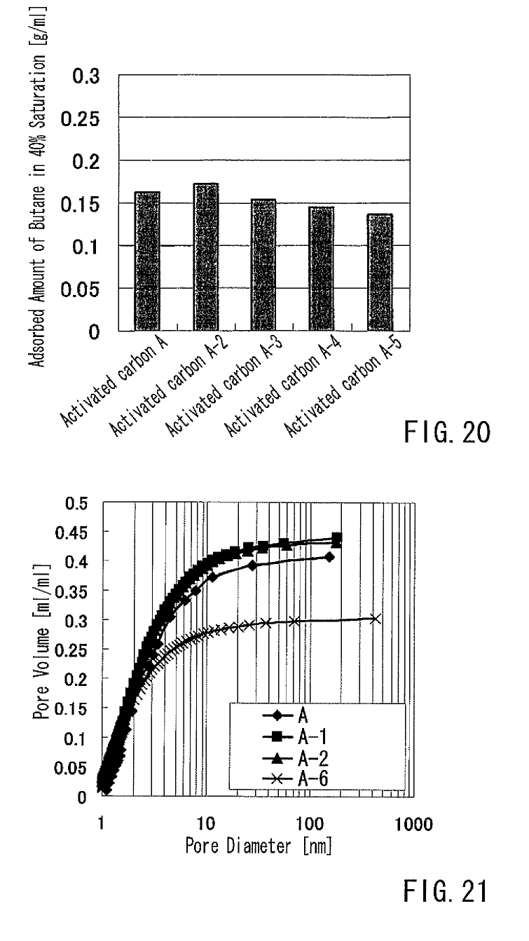

Table 6 shows the adsorbed amount of n-butane under each relative pressure in the activated carbon A and the samples A-1, A-2 and A-6. Table 7 shows the adsorbed amount of n-butane under each relative pressure in the activated carbon B and the samples B-1, B-2 and B-3. FIG. 20 shows the adsorbed amount of n-butane of the activated carbon A and the samples A-2, A-3, A-4 and A-5 under the condition that the relative pressure was 0.4.

TABLE 6

| Relative | | Activated | Sample | Sample | Sample |
|---|---|---|---|---|---|
| Pressure | | carbon A | A-1 | A-2 | A-6 |
| 0.1 | Adsorbed Amount | 0.103 | 0.108 | 0.113 | 0.101 |
| | (g/ml) | | | | |
| | -fold | | 1.04 | 1.09 | 0.97 |
| 0.2 | Adsorbed Amount | 0.129 | 0.134 | 0.140 | 0.117 |
| | (g/ml) | | | | |
| | -fold | | 1.04 | 1.09 | 0.91 |
| 0.3 | Adsorbed Amount | 0.147 | 0.153 | 0.158 | 0.127 |
| | (g/ml) | | | | |
| | -fold | | 1.04 | 1.07 | 0.86 |
| 0.4 | Adsorbed Amount | 0.162 | 0.169 | 0.173 | 0.134 |
| | (g/ml) | | | | |
| | -fold | | 1.04 | 1.07 | 0.83 |

TABLE 7

| Relative | | Activated | Sample | Sample | Sample |
|---|---|---|---|---|---|
| Pressure | | carbon B | B-1 | B-2 | B-3 |
| 0.1 | Adsorbed Amount | 0.071 | 0.105 | 0.076 | 0.071 |
| | (g/ml) | | | | |
| | -fold | | 1.48 | 1.07 | 1.001 |
| 0.2 | Adsorbed Amount | 0.088 | 0.132 | 0.096 | 0.087 |
| | (g/ml) | | | | |
| | -fold | | 1.51 | 1.10 | 0.99 |
| 0.3 | Adsorbed Amount | 0.101 | 0.154 | 0.112 | 0.097 |
| | (g/ml) | | | | |
| | -fold | | 1.51 | 1.10 | 0.95 |
| 0.4 | Adsorbed Amount | 0.115 | 0.175 | 0.127 | 0.107 |
| | (g/ml) | | | | |
| | -fold | | 1.53 | 1.11 | 0.93 |

It is apparent from Tables 6 and 7 that each of the samples has a sufficient adsorbed amount of n-butane even under a relatively low pressure condition. In the samples A-1 and A-2, adsorbed amount of n-butane increases as compared with the activated carbon A in all of the relative pressure conditions. On the other hand, although an increase of the adsorbed amount is able to be predicted in the sample A-6 as compared with the activated carbon A under the condition that the relative pressure is lower than 0.1, the absorbed amount of the sample A-6 is less than that of the activated carbon A under the conditions that the relative pressure is 0.1 or higher and, as the relative pressure becomes higher, the amount of decrease became larger. In the sample A-2, the adsorbed amount of n-butane increases to an extent of not less than 1.07-fold of the activated carbon A. In the sample A-1, the adsorbed amount of n-butane increases to an extent of not less than 1.04-fold of the activated carbon A. On the other hand, in the sample A-6, the adsorbed amount of n-butane decreases by 17% at most as compared with the activated carbon A. Further, in the sample B-1, the adsorbed amount of n-butane significantly increases as compared with the activated carbon B and the adsorbed amount of n-butane was 1.53-fold as compared with the activated carbon B under the condition that the relative pressure was 0.4. In the sample B-2, the adsorbed amount of n-butane was about 1.1-fold as compared with the activated carbon B. In the sample B-3, the adsorbed amount of n-butane decreases as compared with the activated carbon B. From the above results, it has been found that, in the samples A-1, A-2, B-1 and B-2 where the concentrations of sodium silicate are 0.1 to 1.0% by weight, the adsorbed amount is increased as compared with the activated carbons A and B. Then, the optimum conditions for impregnation of silica gel depending upon the difference in pore distribution in the samples of A and B types are evaluated from the viewpoint of pore size distribution of the compounded activated carbon.

<Pore Size Distribution Characteristics>

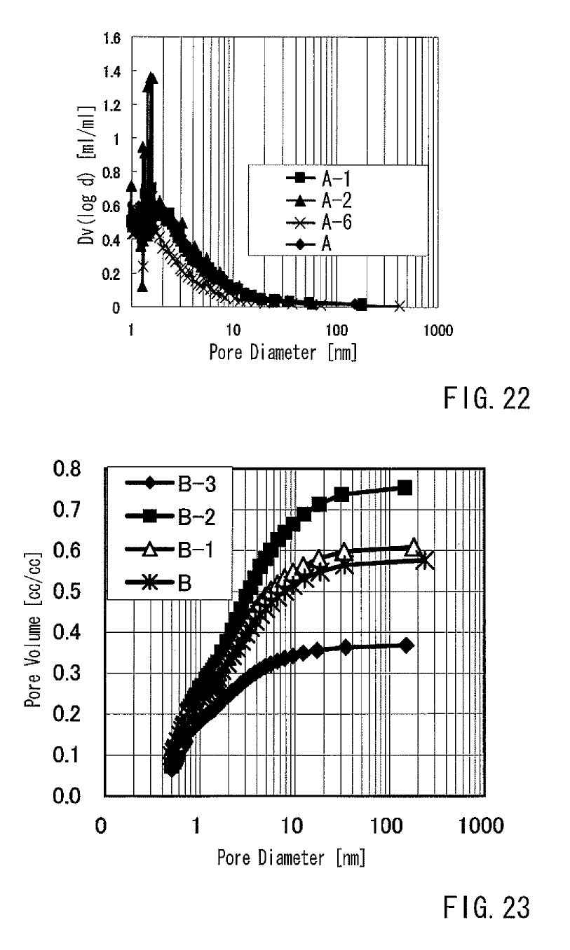

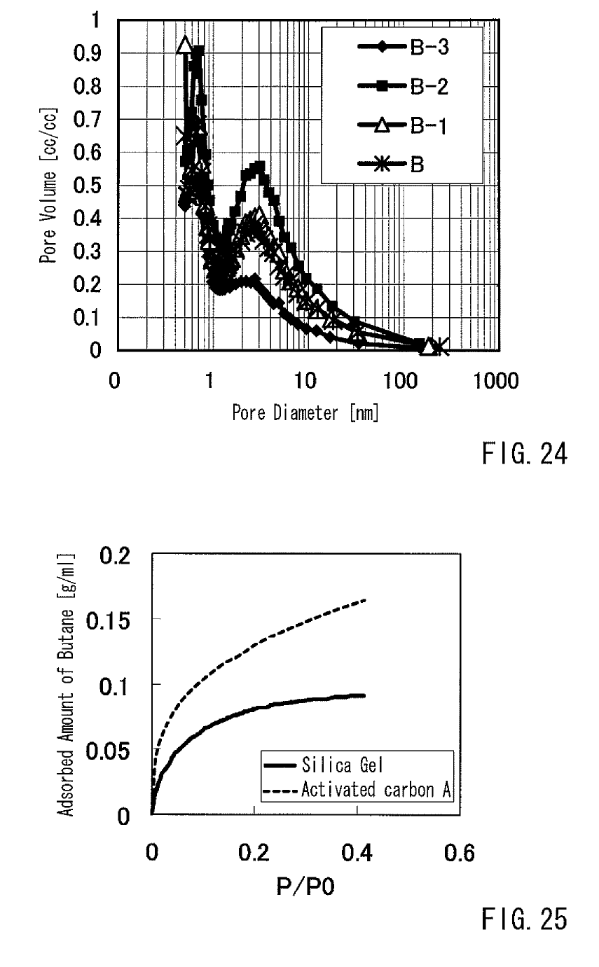

FIG. 21 shows the pore size distribution of the samples A-1, A-2 and A-6. FIG. 22 shows the differential pore size distribution of FIG. 21. FIG. 23 shows the pore size distribution of the samples B-1, B-2 and B-3. FIG. 24 shows the differential pore size distribution of FIG. 23. FIG. 25 shows adsorbed amount of n-butane for the activated carbon A and silica gel. It is noted from FIGS. 21 and 22 that the pore volumes increase as a whole in the samples A-1 and A-2 as compared with the activated carbon A. On the other hand, the pore volume of the sample A-6 decreases as a whole as compared with the activated carbon A. To be more specific, in the samples A-1 and A-2, the pore volume where the pore diameter is about 1 to 4 nm is bigger than that of the activated carbon A. On the other hand, in the sample A-6, although pores having a pore diameter not more than 1.6 nm increase as compared with the activated carbon A, the pore volume (where the pore diameter is 2 to 4 nm) decreases. The above results support the fact that n-butane is mostly adsorbed with the pore region where the pore diameter is about 1 to 5 nm or, particularly, the pore diameter is about 2 to 4 nm, and it is likely that an increase in the pores within such a range greatly participates in an increase in the adsorbed amount of n-butane. It is clearly noted from the result of FIG. 22 that the pore region where the pore diameter is not less than 10 nm greatly decreases and that, among the pore region where the pore size is more than 10 nm, at least 6% or more is made narrow and small by silica gel.

It is noted from FIGS. 23 and 24 that the pore volume of the sample B-2 greatly increases as a whole as compared with the activated carbon B, the pore volume of the sample B-1 increases as a whole from the activated carbon B and that, in the sample B-3, it is nearly one-half of the activated carbon B. Particularly in the sample B-2, pores having 0.4 to 0.6 nm or 2.0 to 3.5 nm pore diameter greatly increase. This result shows the fact that the tendency of the development in the activated carbon B is substantially the same as that of the development of pores by impregnation of silica gel into the pores of the activated carbon A. In the samples A-6 and B-3, adsorption capacity greatly decreases. That is presumably due to remarkable decrease of the pores effective for the adsorption of n-butane. As a result, it has been found that the biggest cause affecting the adsorption of n-butane is a pore size distribution. It is noted from the result of FIG. 25 that a pore region where pore diameter is not smaller than 10 nm greatly decreases and that, among the pore region where the pore diameter is more than 10 nm, at least 6% thereof is made narrow and small by silica gel.

From the above results, it has been found that, in the case that no hydrothermal treatment is carried out, the concentration of an aqueous solution of sodium silicate to be impregnated into the activated carbon where specific surface area is about 1,100 to 2,000 μS/cm is preferred to be about 0.1 to 5.0% by weight and is more preferred to be about 0.1 to 1.0% by weight. As to the reasons for enhancement of adsorption characteristic, there will be the following causes.

(1) As a result of impregnation of silica gel, the pores of activated carbon are made narrow and small, and density of the activated carbon particles increases.

(2) Synergism with adsorptive and desorptive characteristics of the impregnated silica gel itself (from the result of FIG. 21, it is noted that the adsorbed amount of silica gel is about 60% of that of the activated carbon A).

(3) An increase in the pores of 1 to 5 nm effective for the adsorption of n-butane.

In the above Examples, since no hydrothermal treatment is carried out during the manufacturing steps for a compounded activated carbon, if the concentration of the aqueous solution of sodium silicate is near 10% by weight, pore volume of the resulting compounded activated carbon decreases and, as a result, the adsorbed amount of n-butane in the resulting compounded activated carbon decreases as compared with the untreated activated carbon. Accordingly, the samples A-6 and B-3 in which the concentration of the aqueous solution of sodium silicate was made 10% by weight were manufactured via a hydrothermal step and, the effect by the hydrothermal treatment was confirmed by quantitative evaluations based on adsorptive characteristic for n-butane in the same way as above. The samples subjected to a hydrothermal treatment are sample A-6′ and sample B-3′, respectively.

Specific manufacturing method is as follows. Thus, 10 cc each of activated carbon was placed in a flask and deaerated in vacuo for 2 hours using a vacuum pump while heating at 383 K using a mantle heater. Then, after cooling, 150 cc of distilled water was introduced into the flask utilizing the vacuum state and activated carbon was immersed therein for 2 hours. After that, the activated carbon prepared by filtration was immersed for 48 hours in a flask containing 150 cc of a 10% by weight aqueous solution of sodium silicate (Na₂.3.3SiO₂) while stirring the aqueous solution of sodium silicate at 100 rpm. After that, filtration was carried out during 10 minutes and the activated carbon obtained by a solid-liquid separation was dried for 24 hours at 383 K in a thermostat. Then, a deaeration was carried out in vacuo once again under the same condition as above, 75 cc of 1.95 mol/l of sulfuric acid was introduced thereinto, activated carbon was immersed therein at room temperature for 24 hours under the same condition as above and solid-liquid separation and drying were carried out once again in the same manner. After that, washing with an aqueous solution of sulfuric acid at pH 3 was repeated ten times until the electric conductivity of the aqueous solution became not more than 600 μS/cm. Incidentally, the electric conductivity in the initial state was about 850 μS/cm. Then a hydrothermal treatment was carried out for 24 hours at 395 K and 2 atmospheric pressure in an autoclave (A-6′ and B-3′). Finally, maturation was carried out by heating at 385 K for 2 hours in the thermostat to give a compounded activated carbon.

<Pore size Distribution Characteristic>

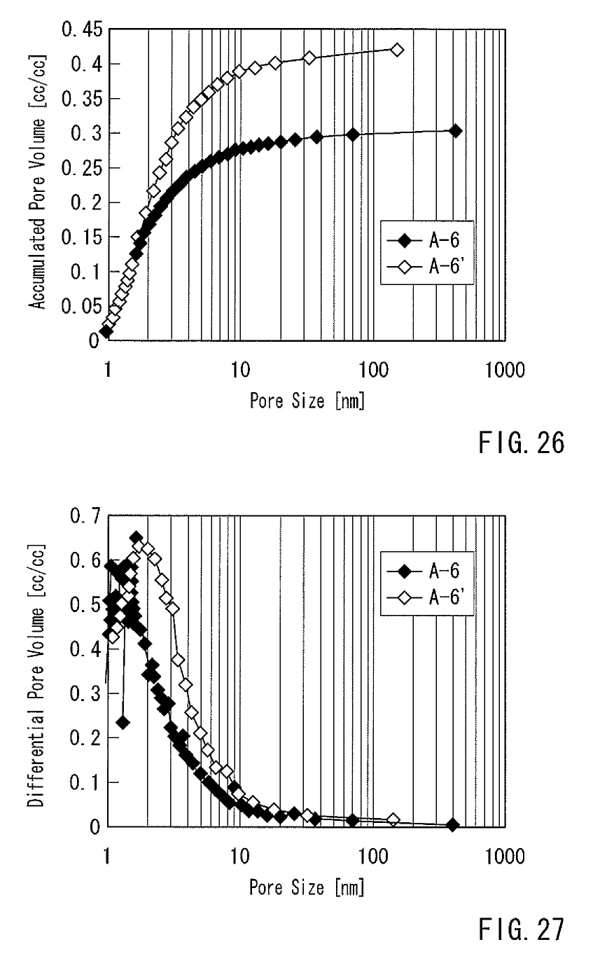

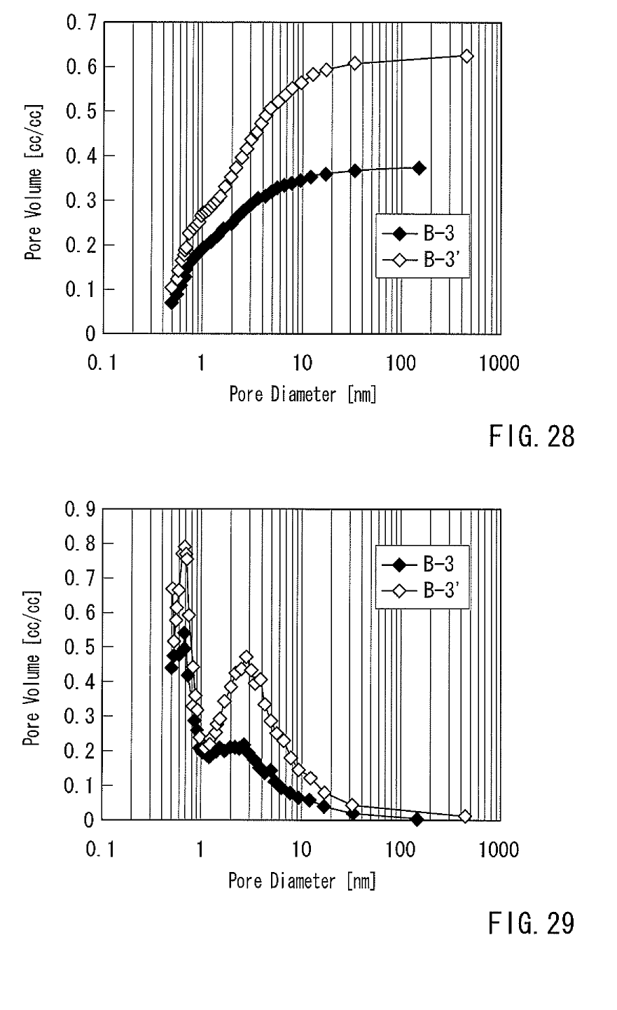

FIG. 26 shows a pore size distribution of the sample A-6′. FIG. 27 shows a differential pore size distribution of FIG. 26. For easier comparison, FIGS. 26 and 27 also show the results for the sample A-6 being same as in FIGS. 21 and 22, respectively. FIG. 28 shows a pore size distribution of the sample B-3′. FIG. 29 shows a differential pore size distribution of FIG. 28. For easier comparison, FIGS. 28 and 29 also show the results for the sample B-3 being same as in FIGS. 23 and 24, respectively. It is noted from the result of FIG. 26 that the pore volume of the sample A-6′ increases as a whole as compared with that of the sample A-6 resulting in the same levels as in the samples A-1 and A-2 (refer to FIG. 21). It is noted from the result of FIG. 27 that, in the sample A-6′, the pore volume where pore diameter is about 2 to 4 nm is bigger than that of the sample A-6 resulting in the same levels as in the samples A-1 and A-2 (refer to FIG. 22). To be more specific, the pore volume where pore diameter 2 to 4 nm in the sample A-6 is 0.0741104 cc/cc while, in the sample A-6′, the pore volume where pore diameter is 2 to 4 nm is 0.136864 cc/cc whereby, in the sample A-6′, although the density is same as in the sample A-6, the pore diameter effective for n-butane increased by 84.7%.

It is noted from the result of FIG. 28 that the pore volume of the sample B-3′ increases as a whole as compared with that of the sample B-3 resulting in the same level as in the sample B-1 (refer to FIG. 23). It is noted from the result of FIG. 29 that, in the sample B-3′, the pore volume where pore diameters are about 0.4 to 0.6 nm and about 2 to 4 nm are bigger than those of the sample B-3 resulting in the level near that of the sample B-2, which is better than the sample B-1 (refer to FIG. 24). To be more specific, the pore volume where pore diameter is 2 to 4 nm in the sample B-3 is 0.056672 cc/cc while, in the sample B-3′, the pore volume where pore diameter is 2 to 4 nm is 0.12384 cc/cc whereby, in the sample B-3′, although the density is same as in the sample B-3, the pore diameter effective for n-butane increased by 118.5%.

From the above results, it has been found that, even when the concentration of an aqueous solution of sodium silicate is as high as about 10% by weight, the pore volume sufficiently increases via the hydrothermal treatment. Thus, it has been found that, in the case that the hydrothermal treatment is carried out, the concentration of an aqueous solution of sodium silicate to be impregnated into the activated carbon where the specific surface are is about 1,100 to 2,000 μS/cm is preferred to be about 0.1 to 10% by weight. Since the density is able to be increased while a good pore volume is ensured, changes in the temperature during absorption and desorption are able to be suppressed whereby the absorptive and desorptive characteristics are able to be more enhanced.

1. An adsorbent where an impregnating substance is impregnated in pores of activated carbon, comprising: a plurality of mesopores and macropores formed in the activated carbon and the impregnating substance is impregnated into the plurality of mesopores and the macropores whereby a pore size ratio within a range of 1 to 10 nm is increased.

2. The adsorbent according to claim 1, wherein the pore region having more than 10 nm pore diameter is made narrow and small by the impregnated substance.

3. The adsorbent according to claim 1, wherein the impregnating substance is silica gel.

4. The adsorbent according to claim 1, wherein the impregnating substance is silica gel of type B.

5. The adsorbent according to claim 1, wherein the adsorbent is molded into a granular shape by using silica gel as a binder.

6. The adsorbent according to claim 1, wherein
the adsorbent is molded into a granular shape by using silica gel as a binder,
the impregnating substance is silica gel, and
the silica gel impregnated into the pores of each activated carbon particle and the silica gel as the binder are simultaneously impregnated by the same material.

7. A canister comprising the adsorbent according to claim 1.

8. A method for the manufacture of an adsorbent, comprising
an immersing step where activated carbon includes at least mesopores and macropores and having a specific surface area of 1,100 to 2,500 m²/g is introduced followed by immersing for at least 12 hours;
a step of making into sol where an acid is added to the activated carbon after the immersing step such that pH of the activated carbon added with the acid is within a range between 3 to 6; and
a step for making into gel where separation into solid and liquid is carried out after the step of making into sol and then the activated carbon is matured by heating
by which silica gel is impregnated into inner areas of the mesopores and the macropores so that a pore size ratio within a range of 1 to 10 nm is increased.

9. The method for the manufacture of an adsorbent according to claim 8, wherein the activated carbon is in the form of finely disintegrated particles.

10. The method for the manufacture of an adsorbent according to claim 8, wherein the step of making into sol is carried out at a temperature of higher than a freezing point of an aqueous solution of alkali metal salt of silicic acid and less than ambient temperature.

11. The method for the manufacture of an adsorbent according to claim 8, wherein the step of making into sol is carried out after drying the activated carbon prepared by a solid-liquid separation after the immersing step.

12. The method for the manufacture of an adsorbent according to claim 8, wherein the immersing step and the step of making into sol are carried out continuously in the aqueous solution of alkali metal salt of silicic acid.

13. The method for the manufacture of an adsorbent according to claim 8, wherein, in the immersing step, a chemical substance for making a pore surface of the activated carbon hydrophilic is added to the aqueous solution of alkali metal salt of silicic acid.

14. The method for the manufacture of an adsorbent according to claim 8, further comprising a step of immersing the activated in distilled water before the immersing step.

15. The method for the manufacture of an adsorbent according to claim 8, further comprising a hydrothermal treating step where the activated carbon is subjected to a hydrothermal treatment before maturing by heating and after the step of making into sol.

16. A method for the manufacture of an adsorbent, comprising
an immersing step where activated carbon is immersed in an aqueous solution of alkali metal salt of silicic acid as a silica gel material in order to impregnate the silica gel into pores of the activated carbon,
a step of making into sol where an acid is added to the activated carbon after the immersing step and
a step of making into gel where a solid-liquid separation is carried out after the step of making into sol and the activated carbon is matured by heating,
wherein in the immersing step, the activated carbon is immersed in a positive electrode side while applying electric field to the aqueous solution.

17. The method for the manufacture of an adsorbent according to claim 16, wherein the activated carbon is immersed in contact with the positive electrode.

18. The method for the manufacture of an adsorbent according to claim 16, wherein the activated carbon is the positive electrode.

19. The method for the manufacture of an adsorbent according to claim 16, wherein
a storage container used in the immersing step comprises an introducing pipe for introducing an aqueous solution of alkali metal salt of silicic acid from the outside of the storage container and a discharging pipe for discharging the aqueous solution in the storage container to the outside of the storage container at a negative electrode side in the storage container,
the introducing pipe and the discharging pipe are provided in an opposing manner and,
in the immersing step, a water flow from the introducing pipe to the discharging pipe is formed at the negative electrode side.

20. The method for the manufacture of an adsorbent according to claim 16, wherein the the electric field is from 0.01 to 1.0 VA.
